(19) United States
(12) Patent Application Publication
(10) Pub. No.: US 2018/0107891 A1
(43) Pub. Date: Apr. 19, 2018

(54) Vehicle Fuel Theft Mitigation System and Method

(71) Applicant: Scancam Industries Pty Ltd, Cremome, VIC (AU)

(72) Inventors: Anthony James Schmidt, Haberfield (AU); Eoin Sean Byrne, Perth (AU)

(21) Appl. No.: 15/556,353

(22) PCT Filed: Mar. 9, 2016
(86) PCT No.: PCT/AU2016/050167

§ 371 Date: Sep. 7, 2017

(30) Foreign Application Priority Data
Mar. 9, 2015 (AU) 2015900834

(51) Int. Cl. G06K 9/32; B67D 7/34

(52) U.S. Cl. CPC G06K 9/3258; G06K 2209/15; B67D 7/34

(57) ABSTRACT

A method and system (10) for mitigating fuel theft relating to refueling or recharging a vehicle by capturing an image of a unique vehicle identification marker (14), such as a an alphanumeric vehicle registration plate, comparing one or more features of the image with a record containing features from a number of images of previously captured unique vehicle identification markers, and providing an alert if the features of the unique vehicle identification marker match features of at least one of the number of unique vehicle identification markers in the record. A request (26) for payment for fuel can be required before fuel delivery is enabled or a debt payment request can be provided if fuel has been delivered but not paid for within a period of time.

### FIELD OF THE INVENTION

The present invention relates to theft mitigation, particularly though not solely, of fuel for vehicles from service stations or electricity recharging stations.

Forms of the present invention will hereinafter be referred to in relation to capturing images of vehicle license plates for the purpose of identifying vehicles used in drive-off fuel theft where fuel is obtained without post-fill payment.

In this specification, the term ‘fuel’ includes liquid fuels, such as gas/petrol and diesel (derv), liquefied gas fuel (such as propane and/or butane and mixes thereof, or liquefied hydrogen fuel), and electricity for rechargeable electric vehicles.

Furthermore, reference to fuel pump or fuel bowser is also deemed to include electric vehicle electricity recharging stations.

It is to be understood that one or more forms of the present invention is/are suitable for other applications where license plate recognition and functionality to provide an alert is required, such as at security gates or other security checkpoints.

### BACKGROUND TO THE INVENTION

Service stations (also known as petrol or gas stations) have a problem whereby persons drive away from a forecourt or bowser (fuel or gas pump) without having for the fuel they have put into their vehicle. Essentially, stealing the fuel.

Many service stations have minimal, if any, procedures and systems to prevent fuel theft, or to at least identify the person or vehicle involved in the theft. Also, such service stations have minimal if any procedures or systems in place to prevent repeat fuel theft offenses.

Such ‘drive-off’ offenses are considered a breach of contract rather than a criminal offense, since buying the fuel is an agreement between the service station operator and the consumer. Thus, excuses of forgetting to pay for the fuel result in minimal punishment or other reason not to ‘re-offend’, aside from reimbursing the station the amount owed and a possible nominal fine. There is no criminal act and therefore no criminal punishment, such as risk of imprisonment or large fine to dissuade offenders or re-offenders.

Some service stations use a simple method of handwriting the car registration number if a driver drives away from the forecourt without paying for the fuel. This relies on the attendant remembering to write down every license plate number, even during busy periods when it is easy to forget or be under pressure to serve customers. Some service stations require the attendants to repay the value of the stolen fuel from wages if they have not noted the license plate number. This places an unfair burden on attendants and can lead to poor staff retention and dissatisfaction.

One solution to the problem of fuel theft has been proposed in US published patent document US 2014/0236444 A1, in which a vehicle emergency operating mode is enabled during refueling until the fuel is paid for. The emergency operating mode includes, for example, limiting the maximum speed of the vehicle. Such a solution not only requires a system to be installed at the refueling point but also requires integration between the vehicle's systems and the system at the refueling point. This is a relatively complex system to adopt and requires either OEM or at least aftermarket integration with vehicle systems, which may require legislative changes to make practical.

Another solution to the problem of fuel theft has been proposed in Australian published patent document AU 2014100772 A1 which describes a vehicle credit history based on previous (positive) payments for fuel and previous (negative) non-payments for fuel. An attendant has the ability to prevent or allow fuel fill based on the credit history.

At least one system of mitigating drive away fuel theft is provided by a camera arrangement that can record the license plate of each vehicle attending a fuel pump. Such a system, if it works at all, will provide an image of the license plate that can be used for identification purposes (such as by the police investigating the fuel theft), but it does not readily help to identify repeat offenders who may go to a different service station or where the attendant does not have time to compare many license plate images with the, license plates on the forecourt or compare a recently obtained license plate image from a recent drive-away with previous images.

It is with such problems in mind that the present invention has been developed.

It has been found desirable to provide a system and/or method of mitigating drive-away fuel theft that improves recognition of a vehicle used in a drive-away fuel theft.

It has been found further desirable to provide a system and/or method of mitigating drive-away fuel theft that identifies vehicle license (registration) numbers used in repeat offenses and provides an alert to a service station attendant.

### SUMMARY OF THE INVENTION

With the aforementioned in mind, an aspect of the present invention provides a method of fuel or energy theft mitigation, including the steps of;
i) Capturing an image of a unique vehicle identification marker;
ii) Comparing the image of the unique vehicle identification marker with a record containing a number of images of unique vehicle identification markers;
iii) Providing an alert if the unique vehicle identification marker matches at least one of the number of unique vehicle identification markers in the record.

As mentioned above, the term ‘fuel’ in this specification includes liquid fuels, such as gas/petrol and diesel (derv), liquefied gas fuel (such as liquefied hydrogen, or propane and/or butane and mixes thereof), and electricity for rechargeable electric vehicles.

Preferably the record containing the number of images of unique vehicle identification markers corresponds to unique vehicle identification markers of vehicles relating to drive-away offenders. For example, offenders who have driven away from a service station and not paid for fuel.

One or more features in the captured image(s) may be identified and compared with one or more of the same type of features in the record of other identification markers. For example, the unique vehicle identification marker may include an alphanumeric vehicle registration, which contains one or more numbers and/or letters, and can be compared with arrangements of numbers and/or letters of recorded vehicle registration plates.

A further aspect of the present invention provides a method of mitigating fuel theft relating to refueling or recharging a vehicle, including the steps of:
capturing an image of a unique vehicle identification marker;
comparing one or more features of the image of the unique vehicle identification marker with a record containing features of a number of images of other unique vehicle identification markers;
providing an alert if the one or more features of the unique vehicle identification marker match(es) features of at least one of the number of the other unique vehicle identification markers in the record.

A notification may be provided to a potential offender that prepayment is required before fuel delivery will be allowed. Such notification may be provided on a display screen adjacent the fuel pump. Fuel may be delivered if the potential offender prepays for fuel.

The potential offender may ensure that one or more missed fuel payments are paid, and may request to have the respective vehicle identification marker image removed from the record of vehicle identification markers relating to offenders.

If granted, removal of the image of the vehicle identification marker may involve deactivation as an identified offender but may remain as a stored image, or may involve completely deleting the image.

A display screen may be provided within the service station for one or more attendants to view the images of the vehicle identification markers as they are obtained.

Alternatively or in addition to showing the vehicle identification marker(s), an alert may automatically show on the service station display to an attendant when an image of a vehicle identification marker matches a vehicle identification marker in the record.

The record may include a database of images of vehicle license plates/registration numbers showing the unique vehicle registration number relating to each vehicle.

When a drive away offense occurs, the attendant (operator) is alerted or becomes aware that dispensed fuel has not been paid for. A drive away incident is logged.

The attendant has an option to complete an incident report. The incident report can include one or more of the vehicle type, vehicle colour, vehicle model, description of the person involved i.e. the potential offender, any unique features about the vehicle or person (such as unusual accessories on the vehicle, tattoos on the person etc.). The image of the vehicle license plate (the unique vehicle identification marker for that vehicle) may also be added to the incident report.

When a drive away event is logged, the image of the vehicle identification marker is added to the record as requiring prepayment the next time the vehicle identification marker is imaged at the next refill at the same or another service station that is connected to the system or to the record. Thus, the record of the number of images of vehicle identification markers can be made available to a number of service stations, which assists in preventing re-offense non-payment for fuel drive-away.

Preferably the image of a vehicle identification marker is displayed at the fuel pump (bowser) while the vehicle is at that pump (bowser). Thus, the person intending to obtain fuel is alerted to the fact that a record has been made of the vehicle attending the service station. This can proactively dissuade a potential offender from committing a fuel theft drive away offense, and at least reminds the person that security monitoring is present.

The display at the pump may also provide a timely reminder to customers of the need to pay for the fuel dispensed.

If the unique vehicle identification marker (such as the vehicle license/registration/number plate) does not have a match within the record, the vehicle is not identified as relating to a previous non-fuel payment event, and therefore fuel can be dispensed to the vehicle as normal (i.e. typically delivery of fuel and then post-delivery payment within the service station.

Where the vehicle identification marker has a match within the record, and the vehicle is not at a location where payment was previously not made, the potential offender is required to make prepayment in order to avoid a repeat drive-away offense.

Where the vehicle identification marker has a match within the record and previous non-payment occurred at the same location where the vehicle is at, prepayment and/or payment of previous non-payment(s) is required before fuel will be dispensed.

The record may include a database of the images of unique vehicle identification marker and/or a database of previous non-payments after fuel delivery (drive-offs or drive-away offenses by taking fuel without payment)

The record may be stored offsite, such as by cloud computing or on a remote server. Online connection between the service station(s) and the record is provided. Thus, at any time the system can interrogate the record to identify any matches for previous non-payments and images of the respective license plate (vehicle identification marker(s)) associated with drive-away offenses.

If a drive-away offender returns to the service station form which they committed the offense, and pays the missed payment, the vehicle identification marker may be removed or deactivated as no longer relating to a drive-away offender within the record.

If a person is willing but unable to pay for fuel, the vehicle identification marker may be added to the record until the payment is made. Therefore, people with a genuine intent to pay, but may have forgotten their money/charge card and only realized after obtaining fuel, have an opportunity to subsequently pay but the system has a record of the potential offense.

The image of each vehicle identification marker may be obtained by at least one camera, preferably by multiple cameras covering differing angles of view of the vehicle. This can help to overcome problems posed by variance in vehicle positions at the pump, other vehicles moving across the field of view of one camera or another, pedestrians crossing the field of view etc.

Preferably a location reference is assigned to each location at which the identification system operates. Each display at the pump(s) may also be given its own unique reference, as may each service station display. Thus, a non-payment of fuel drive-away offense can be identified to a particular pump and/or service station location.

Also, each report on a drive-away offense is given a unique reference so that past reports can readily be identified.

A further aspect of the present invention provides a system for mitigating fuel theft, including at least one imaging device to capture at least one image identifying a vehicle adjacent a fuel pump, electronic storage to maintain a record of the captured images identifying a number of vehicles each previously being at a respective fuel pump, an alert system to provide an alert if image data identifying the vehicle matches previously recorded image data relating to the vehicle and payment for fuel has not been made.

The system may preferably include a stored record of previous drive-off incidents and/or previous non-payment incidents relating to fuel theft.

Preferably, the system further includes a cross referencing system which enables cross referencing of the image data relating to the vehicle with the stored image data relating to the number of vehicles and the stored record of previous drive-off incidents and/or previous non-payment incidents relating to fuel theft.

A display screen may be provided at or in the proximity of the fuel pump providing a notification that prepayment is required.

Preferably, video images may be recorded and/or monitored for activity at a vehicle refueling site, such as at a service station/gas station forecourt. Such video recording may be continuous on an ongoing basis or may record for a period of time before replacing previous recordings.

If an incident is identified (such as a vehicle unique identifier matching a record of a previous drive away incident vehicle), the recorded images can be matched to the incident. Motion/activity at a time associated with the incident can be viewed and/or linked to the incident. A review of activity at or around the occurrence of the incident can therefore be made.

Preferably, when an incident is identified, a time stamp is made and recorded video data is identified covering a period of time before and/or during and/or after the unique vehicle identifier is captured.

Preferably, the recorded video for a required period of elapsed time is identified, such as 10 minutes +/− from the timestamp, and may be used in an assessment of whether to progress with debt recovery.

Preferably the recorded video is used by a person other than the service station operative in order to provide a separate review and decision layer.

### BRIEF DESCRIPTION OF THE DRAWINGS

One or more embodiments of the present invention will hereinafter be described with reference to the accompanying Figures, in which:

FIG. 1 shows a schematic arrangement of a system according to an embodiment of the present invention.

FIG. 2 provides a flow chart of typical operation of the system according to an embodiment of the present invention.

### DESCRIPTION OF PREFERRED EMBODIMENT

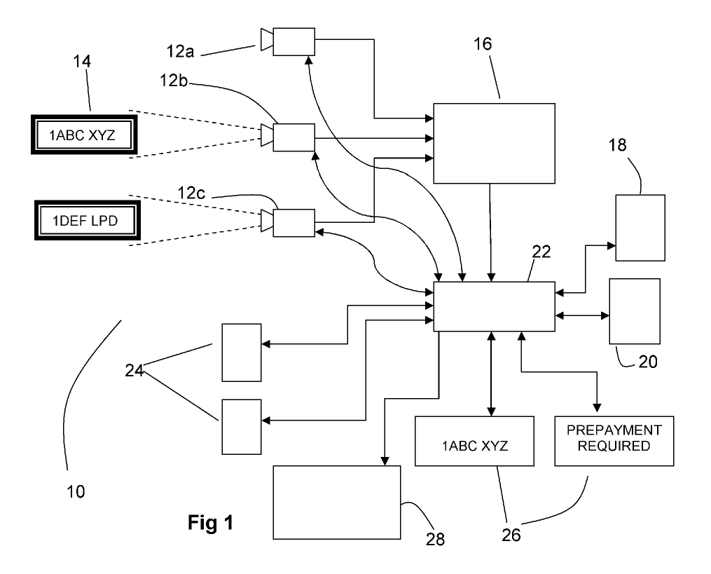

As shown in FIG. 1, one or more cameras 12a . . . 12n are set-up to view a zone adjacent at least one respective fuel pump or recharging station. Hereinafter, for the sake of expediency, the term ‘pump’ will be used to cover liquid fuel and electrical energy delivery devices.

When a vehicle enters a pump zone, at least one of the cameras 12a . . . 12n captures at least one image of the vehicle's license plate 14.

An image of the license plate is stored in a record along with a unique pump identification/reference (PIN) and a date and time stamp.

The captured image(s) is/are communicated to an automatic number plate recognition (ANPR) server 16, which uses character recognition to create a record of the license plate alphanumeric characters.

In this specification, ‘number plate’ is equivalent to ‘license plate’, being the external identification for a particular licensed vehicle.

Each image has associated data relating to the fuel pump at which the vehicle has stopped within the relevant zone. This is a pump identification number (PIN).

Also, the time and date the image is captured are also associated with the image.

The image, PIN and time and date ‘stamp’ are all communicated to the ANPR. The ANPR creates a record of the license plate along with the associated PIN, date and time data.

The license plate is compared with a record of images of license plates already stored on the server. The license plate is also referenced against a drive-off incident database 18 and an IOU (previous non-payment history) database 20.

The results of the reference check are output to a processor 22 which determines what output it makes.

If a match is made between the license plate of the vehicle in the zone and a previously recorded license plate and a drive-off or IOU record, the processor 22 outputs an alert to an attendant/operator (customer service operator or CSO).

The pump can be automatically or manually prevented from dispensing fuel to the customer. The alert can be a visual and/or audible alert, such as on a display screen 24.

A notification can be displayed to the customer at the pump on a display screen 26, such as ‘prepayment required’ or ‘pay at counter before filling’ etc.

One or more notifications or identification of one or more license plates can also or instead be displayed on a display screen 28 for more general viewing, such as in a service station store or kiosk. Thus, general monitoring and awareness can be made of the presence and changing of displayed license plates as vehicles come and go. This provides a general deterrent to potential or opportunist drive-off motorists who will be aware that vehicle monitoring is present. The general display screen can be, for example, a (HD)TV or similar display monitor.

If the reference check is positive i.e. there is a previous record of that vehicle license plate and a previous drive-off or IOU event or outstanding payment, the notification can advise the customer to make prepayment before fuel will be dispensed.

If the reference check returns negative i.e. no match to a previous image of the license plate and/or no previous drive-off for IOU event with payment outstanding, fuel can be dispensed.

However, if the fuel is not paid for i.e. the customer drives off without paying, the service station attendant (also known as a customer service operator or CSO) flags a drive-off event within the system. Thus, in the event of a future attempt to obtain fuel for that vehicle, an image of the license plate will already be recorded, a fresh image of the license plate will be obtained at the that next attempt to obtain fuel and drive-off and IOU for non-payment records will have been previously recorded. Thus, at that next fuel fill event, no fuel will be dispensed until prepayment is received and optionally the previous non-payment (IOU) paid and cleared in the system.

Video footage of the vehicle at the drive off event is also obtained by the camera(s) 12a . . . 12n. This can retrospectively be viewed to try to identify the vehicle and offending person more accurately. Such data can be useful in forming a report on the incident and/or for providing to police.

An incident event can be defined as start time, and date license plate detected, and finish time and date that the CSO confirms the incident occurred (plus, if required, an additional period of time from the start time if confirmation occurs after set time period, e.g. after 10 minutes).

If the camera system cannot recognize a license plate, such as when the license plate is too dirty, misshapen or has an unusual format, the CSO may manually enter the observed license plate into the system (such as via a tablet type display in the service station). Thus, a record is maintained of the license plate even if an image is not available.

The system can prompt the CSO to manually enter the license plate when the camera(s) are unable to obtain a suitable image. The license plate alpha-numeric characters can be entered via a standard keyboard or touchscreen, such as a display screen used to display the original alert.

Manual input by the CSO may include an option to allow the pump/bowser to deliver fuel i.e. an override. For example, if a person has provided payment for fuel for the ‘unknown’ vehicle with the license plate unrecognized by the camera system.

License plate details manually entered into the system are cross referenced to license plate details already stored in the record of previously obtained images of license plates or other manually entered license plate details.

It will be appreciated that the system includes optical character recognition functionality, so that the letters and/or numbers on the license plate can be ‘read’ by the system for comparison with the alphanumeric characters on other license plates.

If a manually entered license plate (i.e. unsuccessfully imaged by the cameras but entered manually by the CSO) or an automatically entered license plate (i.e. license plate successfully imaged by the cameras) has a positive cross reference to license plate details stored in the record, such as the database of previous drive off offenses for that vehicle and/or associated non-payment records, the license plate or other information is displayed to the CSO and optionally at the pump.

Preferably, license plate numbers can be imaged on-demand by the CSO or other authorized person managing the system.

For example, the CSO or an authorized person can control the at least one camera to take an image of a license plate of a vehicle within an image capture zone, such as at a fuel pump.

The command to obtain the image may be, for example, by touching a touch screen/button on a touch screen display in order to initiate or reinitiate automatic image capture of the license plate e.g. should the automatic imaging system have failed in the first instance.

Also, license plate numbers can be manually input into the system for saving in the record (such as a database), if required. For example, if the camera system temporarily fails.

The CSO can be allowed the option to approve delivery of fuel even though the license plate details cannot be manually input, or after the customer has prepaid for fuel, or the CSO can provide for an indication to be sent to the display screen at the pump.

If the customer prepays for fuel, the CSO can allow fuel to be dispensed and can input to the system that payment has been received. This allows the system to send a message to the display screen at the pump that fuel can now be dispensed.

Vehicles associated with a history of non-payment for fuel are prevented from being filled, or repeat offenders are prevented from obtaining fuel, until prepayment is made.

A person may opt to pay off previous unpaid amounts and request to have the license plate deactivated or removed from the record so that future prepayments are not required unless a further active drive away history is established and the prepayment requirement is reinstated.

For a motorist unable to pay for fuel at the time after having obtained fuel, a ‘promise to pay’ or ‘I Owe You’ (IOU) can be generated in the system, which preferably includes obtaining an image of the person's identification (such as a driving license, credit card, passport etc.—preferably being a document containing name and contact details).

An image of their identification can be taken, such as by the CSO, and entered in the system against the IOU and preferably an image of the license plate.

Preferably the customer's full name and address can be manually entered into the system. Vehicle details may also be entered, such as vehicle colour, shape/type, make and/or model. A reason for why the IOU has been allowed and fuel be obtained without payment can also be required.

Identification of the actual CSO, such as an identification number or digital signature, can be required. An IOU report can be generated with the above details.

If the motorist does not subsequently pay or the IOU otherwise repaid, the vehicle is retained on the record and an alert can be given the next time the vehicle is detected at a service station (by imaging the license plate).

If fuel is obtained without payment and a drive-off (drive-away) incident occurs, a report is completed within the system, and footage of the vehicle at the pump is forwarded to the relevant policing authorities and/or relevant stakeholders, such as other service station operators to be alert for the drive away vehicle. The footage is preferably video footage showing several seconds or minutes of video of the vehicle and preferably the person committing the drive-off incident.

Footage of a drive-off offense may be provided to the relevant national police record for the jurisdiction in which the incident has occurred, helping the police/security authorities to monitor, investigate and act on such incidents. Thus, the system and method of one or more embodiments of the present invention can help authorities to control fuel theft and help to capture repeat offenders, and potentially identify stolen vehicles.

In the event that a drive-off incident occurs, but the motorist returns to pay the missed payment (possibly because they simply forgot to pay but then returned to pay), the drive-off incident can be removed from the system once the payment has been made. The image of the license plate is then deactivated or removed from the record. Details of a payment receipt may be input into the system and recorded against the drive-off incident to confirm payment has been made and the incident legitimately cleared.

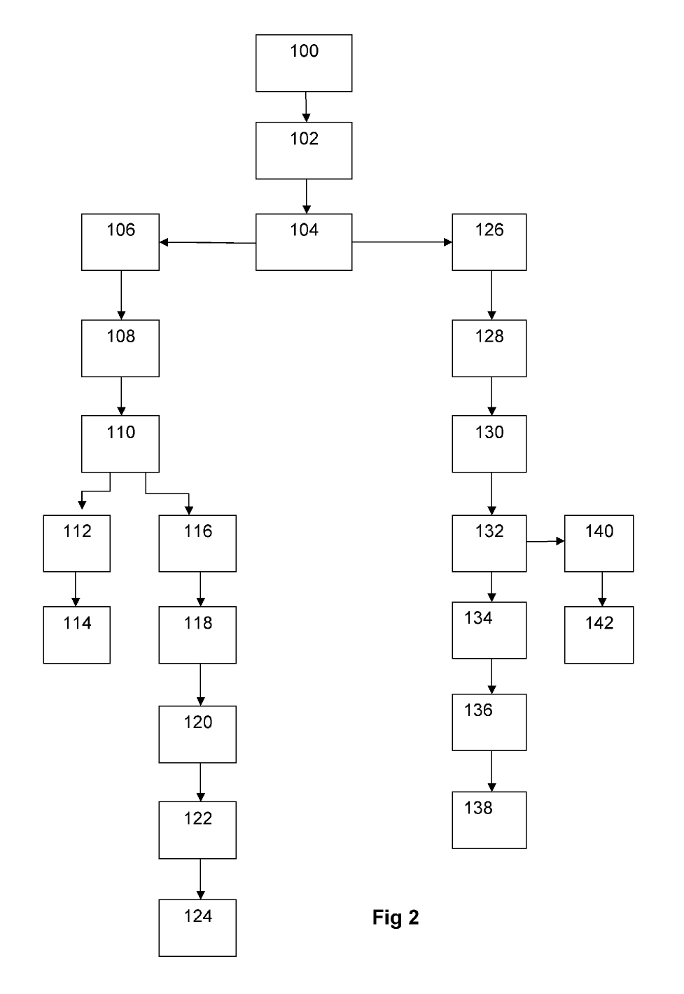

A further embodiment of the present invention is shown as a flow chart in FIG. 2.

According to that flow chart in FIG. 2, a vehicle enters a forecourt 100. At least one camera captures an image 102 of the license plate of the vehicle. The license plate is checked 104 against a record of other stored license plate images and against a list of previous drive-off and/or non-payment offenders.

If the customer is not on the prepayment required list 106, the customer can dispense 108 from the fuel pump, and the customer fills fuel into the vehicle's fuel tank 110.

If the customer then pays for the fuel 112, no alert is made and no further record or check is carried out and the vehicle exits the service station 114.

However, if the customer drives-off 116 without making payment for the fuel, the operator (CSO) is alerted 118 and the drive-off incident logged into the system 120. A drive-off incident report is created 122 by the CSO and the license plate is added to the record. The prepayment required and drive-off records are updated 124 with the license plate details.

Alternatively, if the license plate check 104 reveals that the vehicle has previously been involved in a drive-off incident and payment was not made 126 i.e. suggesting the customer is a repeat offender, the CSO is alerted 128 by an alert to a display screen at the payment kiosk/counter. The display at the fuel pump displays 130 a notice to the customer to make prepayment. No fuel is dispensed.

If the customer prepays for fuel 132, the fuel pump is enabled to dispense fuel 134, the customer can fill their vehicle's fuel tank 136, and exit the service station 138.

Also, if the customer prepays for fuel and clears any previous outstanding payments, they can request to be removed from the (IOU) prepayment required record 140.

The customer can register to be removed from the prepayment required record and that removal can be effected 142 once conditions are complied with.

One or more forms of the present invention can include an arrangement whereby, motorists using a service station or participating group of service stations, can obtain a credit value for the number of attendances and/or the amount of fuel and/or the value of fuel purchased.

Drive-off events or non-payment for fuel can temporarily or permanently result in the credit value being negated or reduced (preferably until at least any missed payments have been reconciled).

1. A method of mitigating fuel theft relating to refueling or recharging a vehicle, including the steps of:
capturing an image of a unique vehicle identification marker;
comparing one or more features of the image of the unique vehicle identification marker with a record containing features of a number of images of other unique vehicle identification markers;
providing an alert if the one or more features of the unique vehicle identification marker match(es) features of at least one of the number of the other unique vehicle identification markers in the record.

2. The method according to claim 1, the record containing the number of images of unique vehicle identification markers corresponds to unique vehicle identification markers of vehicles relating to drive-away incidents.

3. The method of claim 1, including providing a notification that prepayment is required before fuel delivery will be allowed.

4. The method according to claim 3, the notification provided on a display screen adjacent the fuel pump.

5. The method according to claim 1, whereby fuel dispensing is enabled after prepayment is received for the fuel.

6. The method according to claim 1, including generating an alert when an image of a vehicle identification marker matches a vehicle identification marker in the record and a drive-off record and/or previous non-payment record.

7. The method according to claim 1, whereby following payment of one or more missed fuel payments, the respective vehicle identification marker image or a non-payment record or a drive-off record, or a combination of one or more thereof, is requested to be removed from the record.

8. The method according to claim 1, including displaying on at least one display screen at least one image of the vehicle identification marker(s).

9. The method according to claim 1, the record including a database of images of vehicle license plates/registration numbers showing the unique vehicle registration number relating to each vehicle.

10. The method according to claim 1, whereby, when the vehicle identification marker has a match within the record and the vehicle is not at a location where payment was previously not made, prepayment is required before fuel is dispensed.

11. The method according to claim 1, whereby, when the vehicle identification marker has a match within the record and previous non-payment occurred at the same location where the vehicle is at, prepayment and/or payment of previous non-payment(s) is required before fuel will be dispensed.

12. The method according to claim 1, whereby, if the vehicle returns to a location at which a previous drive-off incident occurred, and the previous missed payment(s) are paid, the record of the vehicle identification marker can be removed or deactivated.

13. The method according to claim 1, whereby, if a person is willing but unable to pay for fuel, the vehicle identification marker is added to the record until the payment is made.

14. The method according to claim 1, whereby refueling the vehicle includes dispensing of liquid or liquefied fuel or electrical recharge of the vehicle.

15. A system for mitigating fuel theft, including at least one imaging device to capture at least one image identifying a vehicle adjacent a fuel pump, electronic storage to maintain a record of the captured images identifying a number of vehicles each previously being at a respective fuel pump, an alert system to provide an alert if image data identifying the vehicle matches previously recorded image data relating to the vehicle and payment for fuel has not been made.

16. The system according to claim 15, including a stored record of previous drive-off incidents and/or previous non-payment incidents relating to fuel theft.

17. The system according to claim 15, including a cross referencing system which cross references the image data relating to the vehicle with the stored image data relating to the number of vehicles and the stored record of previous drive-off incidents and/or previous non-payment incidents relating to fuel theft.

18. The system according to claim 15, including a display screen at or in the proximity of the fuel pump providing a notification that prepayment is required.

19. The system according to claim 15, wherein refueling of the vehicles includes supply of liquid or liquefied fuel by a fuel pump or electrical recharge at a recharging station.
